(19) United States
(12) Patent Application Publication
(10) Pub. No.: US 2012/0204240 A1
(43) Pub. Date: Aug. 9, 2012

(54) MULTI-APPLICATION MOBILE AUTHENTICATION DEVICE

(75) Inventors: Serge Barbe, Meudon (FR); Sylvain Chafer, Meudon (FR); Michel Martin, Meudon (FR); Patrice Amiel, Meudon (FR); Jan Nemec, Meudon (FR)

(73) Assignee: GEMALTO SA, Meudon (FR)

(21) Appl. No.: 13/503,296

(22) PCT Filed: Oct. 19, 2010
(86) PCT No.: PCT/EP2010/065702

§ 371 Date: Apr. 20, 2012

(30) Foreign Application Priority Data
Oct. 22, 2009 (EP) 09306000.2

(51) Int. Cl. G06F 21/00

(52) U.S. Cl. 726/4

(57) ABSTRACT

(EN) The invention makes it possible to allow several applications to coexist in the same card; the implementation of the applications uses reading and writing of data by the reader in the same memory location. The invention is a method for exchanging data between a mobile authentication device 3 supporting several applications Z1 to Z3 and a reader dedicated to one application in which the reader sends an authentication command and at least one read and/or write command. The authentication command allows the mobile device to authorise a transaction for at least part of an application Z1 to Z3 supported by the said mobile device. In response to the authentication command, the mobile device selects the application of the device that corresponds to the reader. The read and/or write command is carried out by addressing a definite block of data. In response to the read and/or write command, the mobile device addresses the block of the selected application.

This invention relates to a multi-application mobile authentication device.

A mobile authentication device is an electronic device with a circuit that allows authentication vis-à-vis a reader device in order to authorise a service or access to a service. Typically, mobile authentication devices may have different form factors such as smart cards, memory cards, USB keys, electronic tags, passports etc.

Mobile authentication devices show different levels of complexity. Bank cards, SIM cards or electronic passports are some of the more complex devices and they have a chip that is relatively advanced and expensive. The processing of data by applications is carried out directly by the card and any access to the data goes through the preliminary processing of information by the card operating system.

For other applications that require less security and have physical and financial constraints different from those of complex cards, it is preferable to have a less complex chip. The form factor may be of the electronic tag type, i.e. a flexible object made of cardboard or plastic that requires a very small chip to limit the risk of breakage. For example, that is the case of transport cards or physical access cards such as tickets to museums or other facilities. Because of the number of cards that must be made depending on the associated service, these cards are required to have a very small cost to avoid excess costs for the service.

That is why very simplified cards have been developed, limited to simplified authentication and storage of a data structure that is specific to the application. Because each application can be defined independently from an application of the same type, the result is that the data structures associated with two applications A and B are arranged in the cards with no respective consistency. Consequently, two applications A and B can have similar data structures in their cards, with different semantics and be placed in identical or overlapping locations.

For such applications, a transaction is entirely controlled by the reader. The transaction essentially consists in a combination of reading and writing operations in respect of the data structure or structures in the card. Prior to any read or write sequence, an authentication stage allows the reader to check the authenticity of the card and more specifically that of the data structure contained in it. During the authentication command, the reader specifies the data zone for which it is wishes to be authenticated. And potentially, the card can check the authenticity of the reader and thus the infrastructure, for example by exchanging a key.

Thus, when a card with an application A is held before the reader of an application B, the reader does not authenticate the data of application B and the application transaction cannot take place. The card A can thus only operate with the infrastructure A. It is said to be single-application.

If a card C is required to contain both application A and application B, for example to provide a transport ticket that is compatible with two different transport systems, the positioning of the data of the two applications A and B in the same zone or in two overlapping zones makes it impossible to use the two applications at the same time. Thus, two transport systems in the same town or in two neighbouring towns cannot be interconnected with the help of the same transport ticket without changing the entire infrastructure.

This invention is aimed at making it possible for at least two applications to coexist in the same card; the implementation of the applications requires the reader to read and write data in a memory location defined by the reader. The mechanism used by the invention consists in defining an address shift following an identification step between the reader and the card, and then applying the shift to the reader's read or write addresses. Such a shift makes it possible to change data addressing by the reader into virtual addressing and to make two distinct memories zones correspond in the card, and do away with the need to change the whole infrastructure.

More particularly, the invention is a method for exchanging data between a mobile authentication device supporting several applications and a reader dedicated to an application, where the reader sends an authentication command and at least one read and/or write command. The authentication command allows the mobile device to authorise a transaction for at least part of an application supported by the said mobile device. The read and/or write command is given by addressing a definite data block. In response to the authentication command, the mobile device selects the application of the device that corresponds to the reader. In response to the read and/or write command, the mobile device addresses the block of the selected application.

In different modes of embodiment, the mobile device can apply the authentication command successively to each application and select the first application where the authentication command succeeds. The mobile device can apply the authentication command to each application in a definite order. The authentication command can be applied to an application only if the authentication requested is possible. Each application may be associated with a data structure located in a memory zone, in which authentication can be carried out for part of the data located in the said memory zone.

In another aspect, the invention is a mobile authentication device with at least one communication circuit, at least one accessible memory and one authentication circuit. The communication circuit allows the said device to communicate with a reader. The memory comprises at least two memory zones, where each has a data structure that corresponds to an application, and each structure has at least one data block associated with a key. The authentication circuit is able to authenticate a reader vis-à-vis a key. The authentication circuit automatically selects the application corresponding to the reader. A subsequent read and/or write operation is carried out in the structure of the selected application.

In different modes of embodiment, the authentication circuit can select the application by successively testing a key in each application. A block of a structure can comprise an identifier for locating it in the said structure, in which the authentication is carried out for an application only if a block in the structure comprises the same identifier. The device may further comprise means to determine the priority of applications depending on the latest authentications.

The invention will become clearer in the description below, which refers to the enclosed drawings, where:

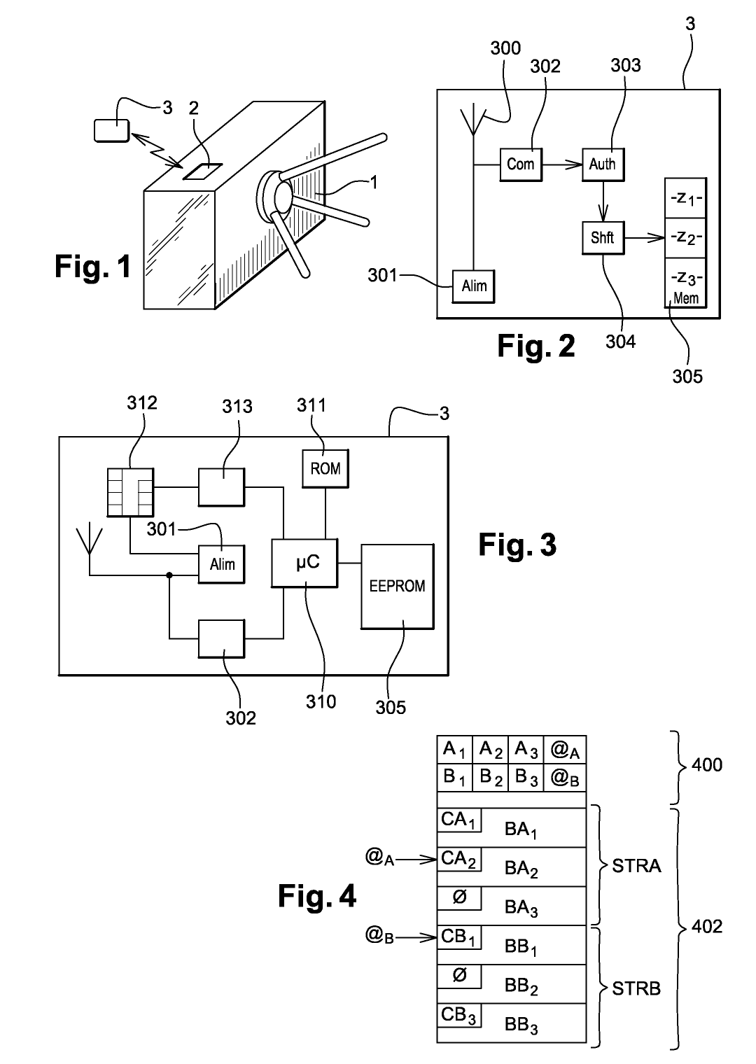

FIG. 1 represents an example of a reader and a mobile device,

FIG. 2 represents a first mode of embodiment of a mobile device according to the invention,

FIG. 3 represents a third mode of embodiment of a mobile device according to the invention, and

FIG. 4 represents the memory diagram of a mobile device according to the invention.

As indicated earlier, the mobile device according to the invention is a mobile identification device, for example for a transport network. FIG. 1 shows the infrastructure 1 for accessing a transport network comprising a reader 2 that communicates with a mobile device 3. Here, the reader 2 is a contactless reader designed to communicate with a transport ticket that may either be a contactless smart card or a ticket of the electronic tag type.

Conventionally, the reader controls a transaction by supplying power to the card and sending it an authentication request. Depending on the transport network, the identification request may vary. For instance, authentication may be carried out differently, by identifying either a type of data structure or the application or service proposed by the reader. In response, the card may merely answer “Yes” or ask the reader to provide it with an access code.

As indicated earlier, many transport networks use a data structure that is specific to them and have their own application or service identifiers. The mobile device in the invention is aimed at being used with several types of transport network. In that way, this authentication phase may enable the mobile device to know which type of application is going to be used in order to be configured accordingly.

FIG. 2 represents a first mode of embodiment, for example in the form of a cardboard electronic tag. In that case, a very small electronic circuit is required and thus each element of the circuit is reduced as much as possible. The device 3 here comprises an antenna 300 connected on one side to a power circuit 301 and on the other side to a communication circuit 302. The power circuit 301 makes it possible to retrieve power voltage and supply it to the other circuits in order to enable them to operate.

The communication circuit makes it possible to modulate and demodulate the signals transmitted and then transmit them to an authentication circuit 303 and a memory 305 via a displacement circuit 304. When communication with the mobile device is established, the first message arrives at the authentication circuit 303. For example, this first message is a request for identifying a data structure. If the data structure is a data structure contained in the card, the authentication circuit sends a message to the reader via communication circuit 302 and then it determines an address shift that it supplies to the displacement circuit 304. The following messages sent by the reader are then sent to the memory 305 which contains applicative data. As they go through the displacement circuit 304 the read and/or write addresses supplied by the reader are affected by the shift determined by the authentication circuit 303. The shift is for example made by merely adding a value equal to the determined shift to the requested address.

For example, the mobile device has three data structures placed respectively in zones Z1, Z2 and Z3 of the memory. Each data structure corresponds to a different application. For an application A, the data structure A is to be stored in a memory from the address @A. In the mobile device, the data structure A is for example placed in the zone Z1 which begins for example with address @1 of the memory 305. The authentication circuit that has identified the application A then provides the displacement circuit with a shift value equal to @1−@A, which value may be negative.

If, on the other hand, the authentication circuit has identified that the application is an application B, where the data structure ought to be placed at an address @B, and that the data structure is in fact placed in zone Z3 and starts at address @3, the calculated shift will be equal to @3−@B.

Such a mobile device also makes it possible to embed two or three different applications.

FIG. 3 represents a variant of embodiment that makes it possible to programme the mobile device one again at will and thus provide greater flexibility of use. One part of the circuits of the device represented in the FIG. 2 is replaced by a microcontroller core 310 with a ROM memory 311. FIG. 3 is a mobile device according to the invention that may for example be a hybrid smart card, that is to say a card with a contact interface and a contactless interface. The contactless interface has an antenna 300 and a first communication circuit 302. The contact interface comprises a connector 312 and a second communication circuit 313. The antenna 300 and the connector 312 are both connected to a power circuit 301 that supplies power to the other circuits. The first and second communication circuits 302 and 313 are both connected to the microcontroller core 310, which emulates the authentication circuit 303 and the displacement circuit 304 shown in FIG. 2. The ROM memory 311 has the microcode required for the microcontroller core 310 to emulate the said circuits. The application memory 305 contains the data structures of the applications supported by the mobile device. The application memory 305 is a non-volatile and rewritable memory, for example of the EEPROM type.

For example, FIG. 4 illustrates a diagram for storing information in the memory 305. In this example, only two data structures STRA and STRB corresponding respectively to an application A and an application B are represented. Each data structure STRA and STRB is divided into data blocks, three blocks per structure in the example: BA1, BA2 and BA3 are the blocks of the structure STRA, and BB1, BB2, BB3 are blocks of the structure STRB. It must be noted that all the blocks of each structure cannot be used. That is so, for example of blocks BA3 and BB2, which are not used.

When a data block of a data structure is used, a key is associated with the block to only allow access by readers than can be authenticated with the key. The reader 2 sends a first authentication command that allows the mobile device to authorise a transaction for a predefined application.

In that way, application A corresponding to the data structure STRA comprises a key CA1 associated with the block BA1 and a key CA2 associated with the block BA2. The application B corresponding to the data structure STRB comprises a key CB1 associated with the block BB1 and a key CB3 associated with the block BB3. When a data reader wishes to be authenticated, it identifies a block and gives its authentication key. If the key given is the same as the key saved, authentication is successful. To automatically determine the application that corresponds to the reader, the microcontroller 310, which emulates an authentication circuit, successively attempts to be authenticated by each application till authentication is successful. In response to the authentication command, the microcontroller 310 of the card 3 selects the application of the device that corresponds to the reader.

Thus, in a first example of embodiment, if an authentication request is made for the first block of a data structure, the microcontroller attempts authentication with the key CA1 of the first block BA1 of the structure STRA; if authentication is successful, the selected application is application A. If authentication does not succeed, the microcontroller attempts authentication with the key CB1 of the first block BB1 of the structure STRB; if authentication is successful, the selected application is application B. If other applications are present, the first keys of the applications are also tested, and when the last application is tested unsuccessfully, an error message is sent back.

If authentication is successful, e.g. with application B, the reader 2 sends a read and/or write command in the data block with which it has first been identified. In response to the read and/or write command, the microcontroller addresses the block corresponding to the application B selected in this manner.

In order to find the selected application faster, an order of priority must be determined to test the different applications. Preferentially, each time authentication is successful, the fact that the first application to test is the one that has just been selected is saved in the memory. If no application is selected, then the order of priority of the applications remains unchanged. If a user is moving about in the same network for a certain period of time, the authentication process will thus be more efficient in terms of access time.

If the test of all the data structures saved in the memory is too long, error messages can always be sent so that the user can present the card once again to the reader, thus making it possible to increase the time required for authentication. In that case, the card will temporarily store, for example using a registry, the application with which the test sequence should be restarted.

In one variant, authentication tests continue after the sending of a message indicating that authentication has failed, so that the microcontroller can save the application that is required before presenting the card to the reader once again. If one considers the few tens of milliseconds required to run the test for all the applications in relation with the movement of a user to take out and present the card once again, which takes about a second, authentication when the card is presented a second time necessarily starts with the correct selected application.

Note that the selection of the application carried out in this way by the authentication mechanism does not require any intervention by the card holder, other than the possible double presentation of the card before the reader.

The person of the art will note that when a data block is empty, the authentication test can be carried out more speedily, as the key is a null key. However, it is possible that the unused memory includes non-erased data that are those of an incorrect key. In order not to waste time, a second example of embodiment consists in separating the memory 305 into two zones 400 and 402, where the first zone 400 comprises a table that is representative of the data structures STRA and STRB placed in the second zone 402. The table of the first zone thus comprises indicators Ai and Bi representing the occupancy of the different blocks of data structures STRA and STRB. Thus, before the microcontroller 310 attempts authentication with the help of the key of a block, it checks if the block is occupied in the table. The information A3 associated with the block BA3 thus allow the microcontroller to not have to test the key of the block BA3.

The use of a table also makes it possible to save one or more addresses for each structure. For example, the address @A or @B of the start of the structure STRA or STRB can be saved. The address may be used to identify the structure and thus the application, where a simple shift to the address @A or @B makes it possible to go from one application to another. Further, it is not necessary to place the different structures at consecutive addresses in the memory, which provides more flexibility for adding applications. The person of the art will note that it is also possible to use one address for each block under consideration in this table.

It is to be noted that the management of the data structure can be made more complex with a card using a microcontroller. The microcontroller core 310 manages the totality of accesses to the memory 305 and it is thus possible to use intermediate logical addressing to optimise the management of the EEPROM memory. A data structure may be placed in two separate memory zones.

A microcontroller card that carries out the logical shift explained above makes it possible to enjoy significant flexibility of use. For example, without limitation, variants of implementation may be put in place to allow:
The addition of a new application simply by adding a new associated data structure and an additional line in the list,
The addition of additional data elements to an existing application, such as for instance the extension of the data of a transport application,
The use of a data structure of one and the same application that is not contiguous; it is up to the multi-application card to rebuild the view that the reader infrastructure wishes to see,
The removal of an application or a part of an application,
Some data elements that belong to several applications.

Among other variants, the invention has been described in relation with a smart card and an electronic tag. However, it goes without saying that the invention applies to all equivalent mobile electronic devices such as for instance USB keys or devices with any smart card or microprocessor form factor, providing the mobile device includes a memory that is accessible after authentication by the reader, which accesses the data. As it has been shown through examples, the use of a contactless or contact type of communication protocol is of little importance.

1. A method for exchanging data between a mobile authentication device (3) supporting several applications (Z1 to Z3, STRA, STRB) and a reader (2) dedicated to an application comprising:
operating the reader (2) to send:
an authentication command that allows the mobile device (3) to authorise a transaction for at least part (BA1, BA2, BB1, BB3) of an application (Z1 to Z3, STRA, STRB) supported by the said mobile device (3),
at least one command to read and/or write a definite data block; and
operating the mobile device to:
in response to the authentication command, selecting the application (Z1 to Z3, STRA, STRB) of the mobile device that corresponds to the reader; and
in response to the read and/or write command, the mobile device addresses the selected application block (Z1 to Z3, STRA, STRB).

2. A method according to claim 1, in which the mobile device applies the authentication command successively to each application and selects the first application where the authentication command succeeds.

3. A method according to claim 2, in which the mobile device applies the authentication command to each application in a predetermined order.

4. A method according to claim 2, in which the authentication command is applied to an application only if the authentication requested is possible.

5. A method according to claim 1, in which each application is associated with a data structure (STRA, STRB) located in a memory zone and in which authentication takes place for part of the data located in the said memory zone.

6. A mobile authentication device (3) comprising:
at least one communication circuit (302, 313) allowing the said device to communicate with a reader (2),
at least one accessible memory (305), where the said memory (305) comprises at least two memory zones (Z1, Z2, Z3), where each has a data structure (STRA, STRB) corresponding to an application and each structure (STRA, STRB) comprises at least one data block (BA1, BA2, BB1, BB3) associated with a key (CA1, CA2, CB1, CB3),
an authentication circuit (303, 310, 31 1) capable of authenticating a reader (2) vis-a-vis a key (CA1, CA2, CB1, CB3),
wherein the authentication circuit (303, 310, 311) automatically selects the application corresponding to the reader, and in that a subsequent read and/or write operation is carried out in the structure of the selected application.

7. A device according to claim 6, where the authentication circuit selects the application by testing a key (CA1, CA2, CB1, CB3) successively in each application.

8. A device according to claim 7, where the block of a structure (STRA, STRB) comprises an identifier making it possible to locate it in the said structure and where authentication is carried out for an application only if a block of the structure comprises the same identifier.

9. A device according to claim 7, having means to determine the priority of the applications on the basis of the latest authentications carried out.
